(19) United States
(12) Patent Application Publication
(10) Pub. No.: US 2022/0400068 A1
(43) Pub. Date: Dec. 15, 2022

(54) VEHICLE CUSTOMIZED CONNECTIVITY AUGMENTED MAPPING FOR NAVIGATION AND DIAGNOSIS

(71) Applicant: FORD GLOBAL TECHNOLOGIES, LLC, Dearborn, MI (US)

(72) Inventors: Oliver LEI, Windsor (CA); Allen R. MURRAY, Lake Orion, MI (US)

(21) Appl. No.: 17/347,274

(22) Filed: Jun. 14, 2021

(51) Int. Cl. H04L 12/26; H04W 24/10; G06Q 10/06

(52) U.S. Cl. CPC H04L 43/0811; H04L 43/067; H04L 43/045; H04L 43/0894; H04L 43/50; H04W 24/10; G06Q 10/06393

(57) ABSTRACT

Using key performance indicator (KPI) data sensed by vehicles is provided. A data server is programmed to receive, over a wide-area network from a plurality of vehicles, connectivity data of modems of the plurality of vehicles to the wide-area network, the connectivity data indicating KPI data, which road segment was being traversed when the KPI data was captured, and a time period during which the KPI data was captured. The data server is further programmed to identify outlier data elements in the KPI data using outlier detection criteria; and compile the KPI data per road segment and time period excluding the outlier data elements.

### TECHNICAL FIELD

Aspects of the disclosure generally relate to vehicle customized connectivity-augmented map for navigation and diagnosis.

### BACKGROUND

In a vehicle telematics system, a telematics control unit (TCU) may be used for various remote control services, such as over the air (OTA) software download, eCall, and turn-by-turn navigation. An autonomous vehicle is a vehicle that is capable of sensing its environment and navigating without human input. As compared to traditional telematics systems, autonomous vehicles may have greater data upload and download requirements.

### SUMMARY

In one or more illustrative embodiments, a system for using key performance indicator (KPI) data sensed by vehicles is provided. A data server is programmed to receive, over a wide-area network from a plurality of vehicles, connectivity data of modems of the plurality of vehicles to the wide-area network, the connectivity data indicating KPI data, which road segment was being traversed when the KPI data was captured, and a time period during which the KPI data was captured. The data server is further programmed to identify outlier data elements in the KPI data using outlier detection criteria; and compile the KPI data per road segment and time period excluding the outlier data elements.

In one or more illustrative embodiments, a vehicle using KPI data sensed by vehicles is provided. The vehicle includes one or more modems, each configured to communicate over a wide-area network and to capture KPI data with respect to connection of the one or more modems to the wide-area network. The vehicle further includes a processor, programmed to send a request to a data server for KPI data for constructing a route from a start location to an end location, receive the KPI data as requested, filter the KPI data according to capabilities of the vehicle, the capabilities including one or more of frequencies supported by the one or more modems of the vehicle or network operator or network technologies supported by the one or more modems, and construct the route according to route criteria and the KPI data.

In one or more illustrative embodiments, a method for using KPI data sensed by vehicles is provided. Over a wide-area network from a plurality of vehicles, KPI data of modems of the plurality of vehicles to the wide-area network is received, the KPI data further indicating which road segment was being traversed when the KPI data was captured and a time period during which the KPI data was captured. Outlier data elements in the KPI data are identified using outlier detection criteria. The KPI data per road segment and time period is compared excluding the outlier data elements. From one of the plurality of vehicles, a request for the KPI data for a road segment and time period is received. The KPI data, as requested, is sent to the one of the plurality of vehicles. From the one of the plurality of vehicles, actual KPI data captured by the one of the plurality of vehicles is received. The KPI data per road segment and time period is recompiled utilizing the actual KPI data.

### BRIEF DESCRIPTION OF THE DRAWINGS

FIG. 1 illustrates an example system including vehicles implementing bandwidth sharing features for communication with an autonomous vehicle data server;

FIG. 2 illustrates an example diagram of the vehicle implementing bandwidth sharing features;

FIG. 3 illustrates an example illustration of key performance indicator (KPI) data sensed by vehicles;

FIG. 4A illustrates an example map displaying KPI data for a first time period;

FIG. 4B illustrates an example map displaying KPI data for a second time period;

FIG. 5 illustrates an example distribution of KPI data for a road segment;

FIG. 6 illustrates an example process for the collection, summarizing, and dissemination of reported KPI data; and

FIG. 7 illustrates an example process for the operation of the vehicles using the KPI data services of the autonomous vehicle data server.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

An autonomous vehicle (AV) may use cellular and/or WiFi connectivity to communicate with a remote server providing infotainment services (such as streaming video, to support a Wi-Fi hot spot, etc.). Connectivity KPIs, such as throughput and latency, may be relevant in the support of such services. However, connectivity quality may vary due to various factors such as network technology, deployment coverage, bandwidth used, terrain topology, and time of the day. In some examples, the AV may use multiple cellular modems subscribed to different network operators to improve overall connectivity. Even so, this may not always provide adequate connectivity for various services.

The AV connectivity modems may be used to sense connectivity KPI and record the KPI along with location data, network information, and timestamps while driving on the road. The sensed data may be uploaded to the server. The server may collect the data from the vehicles and build a connectivity augmented map. This map can be used by the AVs to allow ride services to plan routes (along with start times) with connectivity augmentation information to meet the needs of the connected vehicle services from different riders.

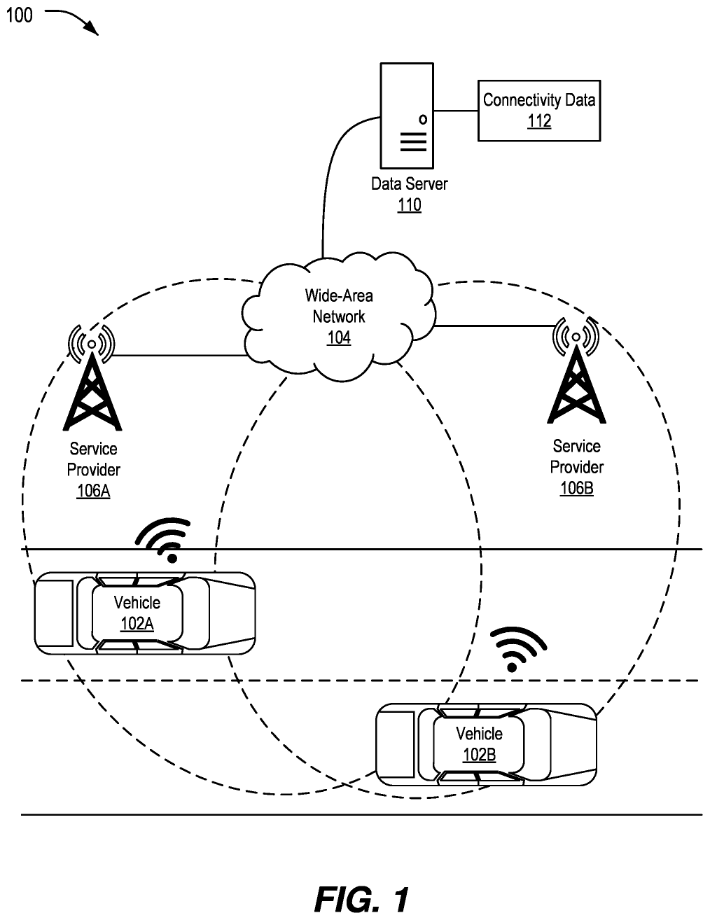

FIG. 1 illustrates an example system 100 including vehicles 102 implementing bandwidth mapping features for communication with an autonomous vehicle data server 110. As shown, the system 100 includes vehicles 102A and 102B (collectively vehicles 102) configured to wirelessly communicate with service providers 106A and 106B (collectively service providers 106) and/or wireless stations 108 over a wide-area network 104. The autonomous vehicle data server 110 is also in communication with the wide-area network 104. The vehicles 102 may communicate with one another via Wi-Fi or other wireless communication protocols to allow a vehicle 102 to utilize the connectivity of other vehicles 102. While an example system 100 is shown in FIG. 1, the example components as illustrated are not intended to be limiting. Indeed, the system 100 may have more or fewer components, and additional or alternative components and/or implementations may be used. As an example, the system 100 may include more or fewer vehicles 102, service providers 106, wireless stations 108, and or autonomous vehicle data servers 110.

The vehicles 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle, a parallel hybrid electrical vehicle, or a parallel/series hybrid electric vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume.

The wide-area network 104 may include one or more interconnected communication networks such as the Internet, a cable television distribution network, a satellite link network, a local area network, a wide area network, and a telephone network, as some non-limiting examples. By accessing the wide-area network 104, the vehicle 102 may be able to send outgoing data from the vehicle 102 to network destinations on the wide-area network 104, and receive incoming data to the vehicle 102 from network destinations on the wide-area network 104.

The service providers 106 may include system hardware configured to allow cellular transceivers of the vehicles 102 to access the communications services of the wide-area network 104. In an example, the service provider 106 may be a Global System for Mobile communication (GSM), 4G Long Term Evolution (LTE) or 5G cellular service provider. In another example, the service provider 106 may be a code division multiple access (CDMA) cellular service provider. It should be noted that these are only examples, and more or different cellular technologies may be used.

Autonomous vehicles 102 function by utilizing vehicle sensor data and other road environmental data in combination with various driving algorithms. The autonomous vehicle data server 110 may include computing hardware configured to provide autonomous data services to the vehicles 102. In addition, the autonomous vehicle data server 110 may maintain connectivity data 112. The connectivity data 112 may include, for example, information with respect to KPIs such as throughput and latency for different segments of the road data. The connectivity data 112 may also include other information, such location data, network information, and timestamp data with respect to the KPIs.

The vehicles 102 may receive connectivity data 112 of the upcoming vehicle 102 environment from the autonomous vehicle data server 110. Using the connectivity data 112, the vehicles 102 may receive KPI information with respect to the vehicle's placement along a route. For instance, the vehicle 102A is in the coverage area of service provider 106A, while the vehicle 102B is in the coverage area of service provider 106B. The autonomous vehicles 102 may also be configured to upload sensed road environmental data to cause the autonomous vehicle data server 110 to update the connectivity data 112. Accordingly, the autonomous vehicle data server 110 may be further configured to update the connectivity data 112 based on information provided to the autonomous vehicle data server 110 from the vehicles 102.

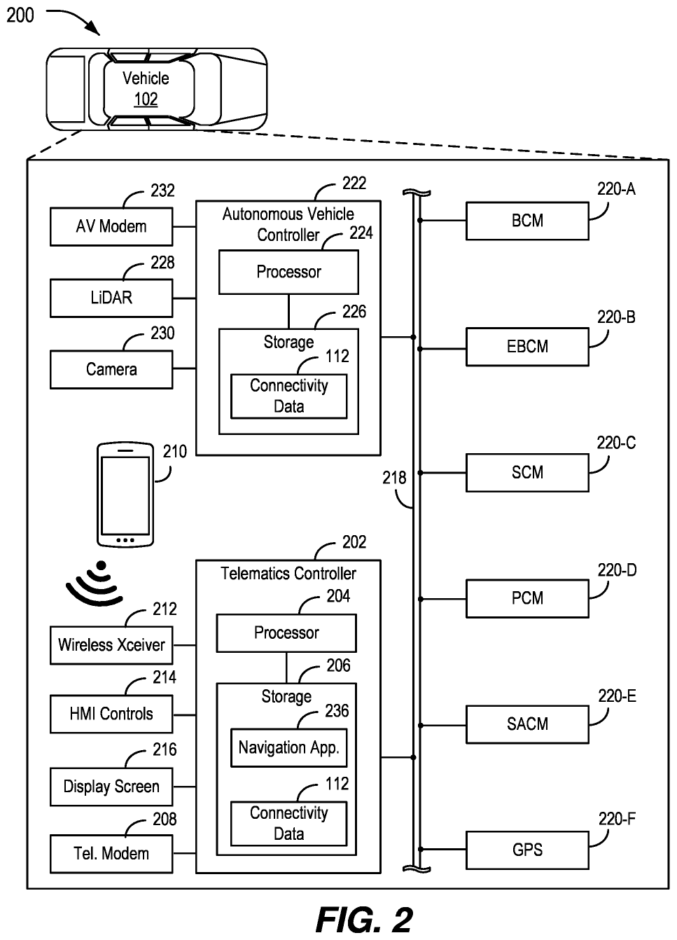

FIG. 2 illustrates an example diagram 200 of the vehicle 102 implementing bandwidth mapping features for communication with an autonomous vehicle data server 110. The vehicle 102 includes a telematics controller 202 configured to communicate over the wide-area network 104. This communication may be performed using a telematics modem 208 of the telematics controller 202. Each vehicle 102 also includes an autonomous vehicle controller 222 additionally configured to communicate over the wide-area network 104 using a dedicated autonomous vehicle modem 232. While an example vehicle 102 is shown in FIG. 2, the example components as illustrated are not intended to be limiting. Indeed, the vehicle 102 may have more or fewer components, and additional or alternative components and/or implementations may be used.

The telematics controller 202 may be configured to support voice command and BLUETOOTH interfaces with the driver and driver carry-on devices (e.g., mobile devices 210), receive user input via various buttons or other controls, and provide vehicle status information to a driver or other vehicle 102 occupants. An example telematics controller 202 may be the SYNC system provided by FORD MOTOR COMPANY of Dearborn, Mich.

The telematics controller 202 may further include various types of computing apparatus in support of performance of the functions of the telematics controller 202 described herein. In an example, the telematics controller 202 may include one or more processors 204 configured to execute computer instructions, and a storage 206 medium on which the computer-executable instructions and/or data may be maintained. A computer-readable storage medium (also referred to as a processor-readable medium or storage 206) includes any non-transitory (e.g., tangible) medium that participates in providing data (e.g., instructions) that may be read by a computer (e.g., by the processor(s) 204). In general, a processor 204 receives instructions and/or data, e.g., from the storage 206, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Python, Java Script, Perl, etc.

The telematics controller 202 may be configured to communicate with mobile devices 210 of the vehicle occupants. The mobile devices 210 may be any of various types of portable computing device, such as cellular phones, tablet computers, smart watches, laptop computers, portable music players, or other devices capable of communication with the telematics controller 202. As with the telematics controller 202, the mobile device 210 may include one or more processors configured to execute computer instructions, and a storage medium on which the computer-executable instructions and/or data may be maintained. In many examples, the telematics controller 202 may include a wireless transceiver 212 (e.g., a BLUETOOTH controller, a ZIGBEE transceiver, a Wi-Fi transceiver, etc.) configured to communicate with a compatible wireless transceiver of the mobile device 210. Additionally, or alternately, the telematics controller 202 may communicate with the mobile device 210 over a wired connection, such as via a USB connection between the mobile device 210 and a USB subsystem of the telematics controller 202. Additionally, or alternately, the telematics controller 202 may utilize the wireless transceiver 212 to communicate with Wi-Fi transceivers of wireless stations 108 within the vicinity of a roadway traversed by the vehicle 102. As yet another example, the telematics controller 202 may utilize the wireless transceiver 212 to communicate with other vehicles 102 traversing the roadway.

The telematics controller 202 may also receive input from human-machine interface (HMI) controls 214 configured to provide for occupant interaction with the vehicle 102. For instance, the telematics controller 202 may interface with one or more buttons or other HMI controls 214 configured to invoke functions on the telematics controller 202 (e.g., steering wheel audio buttons, a push-to-talk button, instrument panel controls, etc.). The telematics controller 202 may also drive or otherwise communicate with one or more displays 216 configured to provide visual output to vehicle occupants, e.g., by way of a video controller. In some cases, the display 216 may be a touch screen further configured to receive user touch input via the video controller, while in other cases the display 216 may be a display, without touch input capabilities. In an example, the display 216 may be a head unit display included in a center console area of the vehicle 102 cabin. In another example, the display 216 may be a screen of a gauge cluster of the vehicle 102.

The telematics controller 202 may be further configured to communicate with other components of the vehicle 102 via one or more vehicle buses 218. The vehicle buses 218 may include one or more of a vehicle controller area network (CAN), an Ethernet network, and a media oriented system transfer (MOST), as some examples. The vehicle buses 218 may allow the telematics controller 202 to communicate with other vehicle 102 systems, such as a body control module (BCM) 220-A, an electronic brake control system (EBCM) 220-B, a steering control system (SCM) 220-C, a powertrain control system (PCM) 220-D, a safety control system (SACM) 220-E, and a global positioning system (GPS) 220-F. As depicted, the controllers 220 are represented as discrete modules and systems. However, the controllers 220 may share physical hardware, firmware, and/or software, such that the functionality from multiple controllers 220 may be integrated into a single controller 220, and that the functionality of various such controllers 220 may be distributed across a plurality of controllers 220.

The BCM 220-A may be configured to support various functions of the vehicle 102 related to control of current loads feeding off the vehicle 102 battery. Examples of such current loads include, but are not limited to, exterior lighting, interior lighting, heated seats, heated windshield, heated backlight, and heated mirrors. Additionally, the BCM 220-A may be configured to manage vehicle 102 access functions, such as keyless entry, remote start, and point of access status verification (e.g., closure status of the hood, doors and/or trunk of the vehicle 102).

The EBCM 220-B may be configured to control braking functions of the vehicle 102. In some examples, the EBCM 220-B may be configured to receive signal information from vehicle wheel sensors and/or drivetrain differentials, and manage anti-lock and anti-skid brake functions through control of brake line valves that adjust brake pressure from the master cylinder.

The SCM 220-C may be configured to aid in vehicle steering by augmenting or counter-acting steering effort provided to the vehicle 102 wheels. In some cases, the augmented steering effort may be provided by a hydraulic steering assist configured to provide controlled energy to the steering mechanism, while in other cases the augmented steering effort may be provided by an electric actuator system.

The PCM 220-D may be configured to perform engine control and transmission control functions for the vehicle 102. With respect to engine control, the PCM 220-D may be configured to receive throttle input and control actuators of the vehicle engine to set air/fuel mixture, ignition timing, idle speed, valve timing, and other engine parameters to ensure optimal engine performance and power generation. With respect to transmission control, the PCM 220-D may be configured to receive inputs from vehicle sensors such as wheel speed sensors, vehicle speed sensors, throttle position, transmission fluid temperature, and determine how and when to change gears in the vehicle 102 to ensure adequate performance, fuel economy, and shift quality.

The SACM 220-E may be configured to provide various functions to improve the stability and control of the vehicle 102. As some examples, the SACM 220-E may be configured to monitor vehicle sensors (e.g., steering wheel angle sensors, yaw rate sensors, lateral acceleration sensors, wheel speed sensors, etc.), and control the BCM 220-A, SCM 220-C, and/or PCM 220-D. As some possibilities, the SACM 220-E may be configured to provide throttle input adjustments, steering angle adjustments, brake modulation, and all-wheel-drive power split decision-making over the vehicle bus 218 to improve vehicle stability and controllability. It should be noted that in some cases, the commands provided by the SACM 220-E may override other command input provided by the driver or by the autonomous vehicle controller 222.

The GPS 220-F configured to provide vehicle 102 current location and heading information, and various other vehicle controllers 220 configured to cooperate with the telematics controller 202.

The autonomous vehicle controller 222 may include and/or communicate with various types of computing apparatus to facilitate the performance of the autonomous vehicle 102 functions. In an example, the autonomous vehicle controller 222 may include one or more processors 224 configured to execute computer instructions, and a storage medium 226 on which the computer-executable instructions and/or connectivity data 112 may be maintained.

The autonomous vehicle controller 222 may receive input from various sensors. In an example, the autonomous vehicle controller 222 may be in communication with Lidar sensors 228. In other example, the autonomous vehicle controller 222 may additionally or alternately be in communication with laser, radar, sonar, or other types of distance and/or obstacle sensors. The autonomous vehicle controller 222 may be in communication with one or more camera 230 devices configured to capture information regarding the surroundings of the vehicle 102.

The autonomous vehicle controller 222 may further utilize an autonomous vehicle modem 232 to communicate data (e.g., the connectivity data 112) between the vehicle 102 and the autonomous vehicle data server 110 accessible over the wide-area network 104. In some examples, the autonomous vehicle modem 232 may be configured to communicate with the same service provider 106 providing communications services to the telematics modem 208. In other examples, autonomous vehicle modem 232 may be configured to communicate with a different service provider 106 than the service provider 106 providing communications services to the telematics modem 208. In one example, the telematics modem 208 may access the wide-area network 104 using the service provider 106A shown in FIG. 1, while the autonomous vehicle modem 232 may access the wide-area network 104 using the service provider 106B shown in FIG. 1.

The autonomous vehicle controller 222 may utilize driving algorithms to command braking, steering, acceleration, and other functions of the vehicle 102. These algorithms may be stored to the storage medium 226 and executed by the one or more processors 224 of the autonomous vehicle controller 222 to command the vehicle 102. The autonomous vehicle controller 222 may accordingly command the vehicle 102 based on inputs such as the connectivity data 112 received from the autonomous vehicle data server 110, sensor input received from the Lidar sensors 228 (or other sensors), image input received from the one or more camera 230 devices, and data from the various controllers 220 received over the vehicle bus 218.

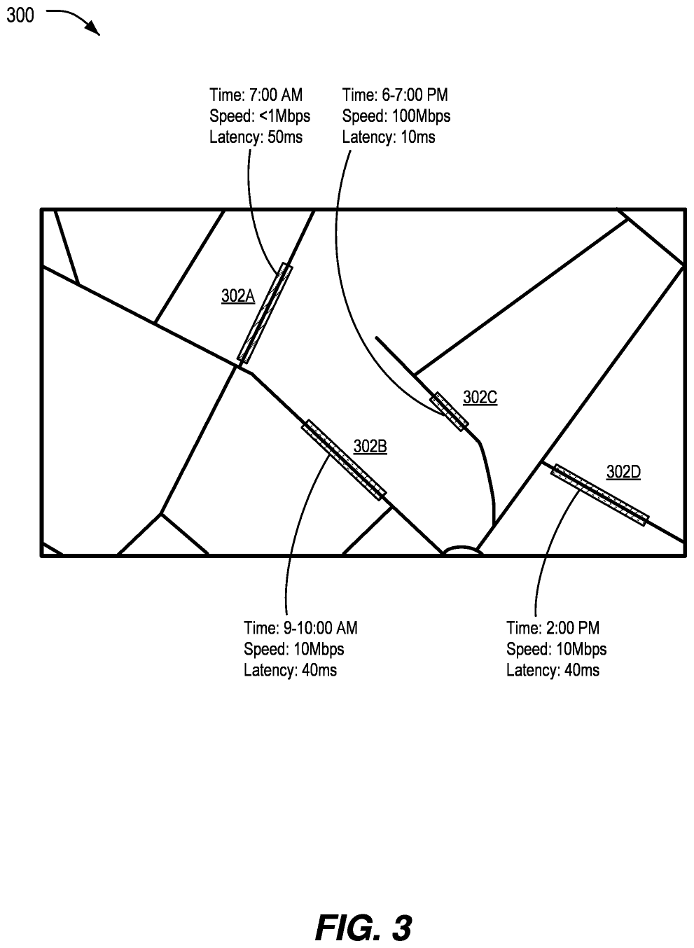

FIG. 3 illustrates an example illustration 300 of KPI data 302 sensed by vehicles 102. The KPI data 302 may be determined by the vehicles 102 using the telematics modem 208 and/or the AV modem 232 and sent by the vehicles 102 to the AV data server 110 via the wide-area network 104. The KPI data 302 may include information such as: download/upload throughput range (e.g., 0 Mbps, <1 Mbps, 5-10 Mbps, >100 Mbps); average ping latency (e.g., 20 ms, 50 ms, 200 ms); global navigation satellite system (GNSS) location data; time of collection (e.g., 7:00 am, 8:00 am, 9:00 am, 11:00 am, 3:00 pm, 5:00 pm, 6:00 pm, etc.); network technology (e.g., LTE, 4G, 5G, etc.); radio frequency (RF) frequency (850 MHz, 2.5 GHz, 28 GHz, etc.); network operator, or no cellular network coverage for network operator of telematics modem 208 and/or AV modem 232, etc.

The vehicles 102 may periodically upload KPI data 302 to the AV data server 110, along with its modem international mobile subscriber identity (IMSI) data. If connectivity is unavailable, the vehicles 102 may store the KPI data 302 and upload at a time where there is connectivity. The vehicles 102 may also piggyback the sensing and upload if a vehicle 102 occupant is using wireless services (e.g., via connection of the telematics controller 202 to a mobile device 210 of the occupant.

As shown at KPI data 302A, for a first road segment at 7:00 AM a network speed of <1 Mbps and a latency of 50 ms was observed by a vehicle 102. At KPI data 302B, for a second road segment at 9-10:00 AM a network speed of 10 Mbps and a latency of 40 ms was observed by a vehicle 102. At KPI data 302C, for a third road segment at 6-7:00 PM a network speed of 100 Mbps and a latency of 10 ms was observed by a vehicle 102. At KPI data 302D, for a fourth road segment at 2:00 PM a network speed of 10 Mbps and a latency of 40 ms was observed by a vehicle 102.

The AV data server 110 may collect the reported KPI data 302, summarize the KPI data 302, and augment digital map information using the summarized KPI data 302. For instance, the summarization may be done per road segment and per time period (e.g., each hour for 24 periods for a day). The map, as augmented, may be presented to vehicle 102 occupants. The presentation of the connectivity along road segments may be displayed in various ways, such as: colored lines, symbols, or other representations of the connectivity data for the corresponding time of day. Thus, the map presentation may be different for the same location, but a different time. For example, a map of the same location at 8:00 AM may appear with different connectivity information as compared to a map of the same location at 10:30 AM.

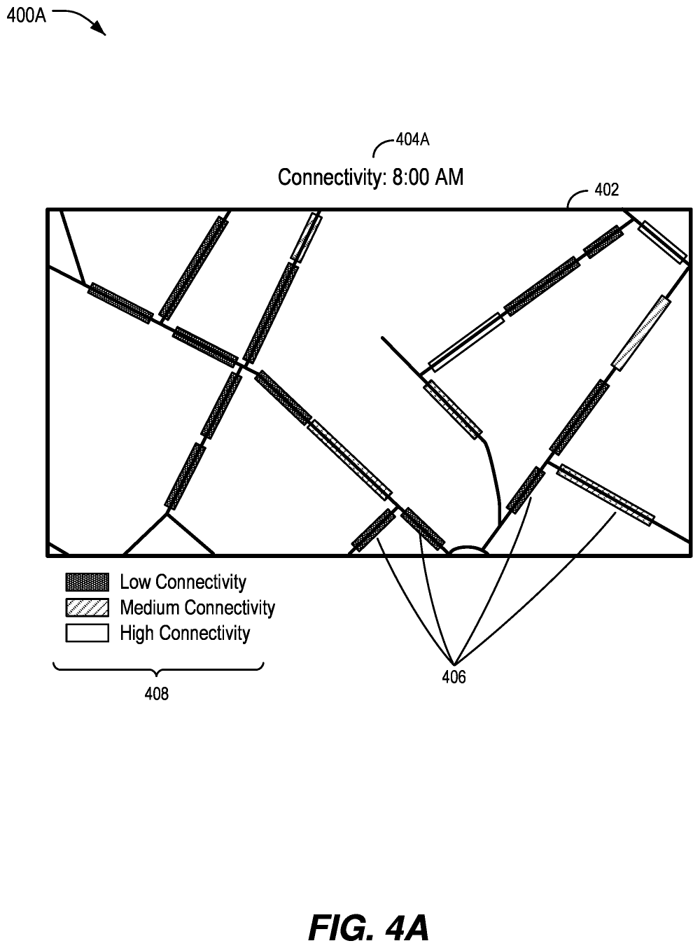

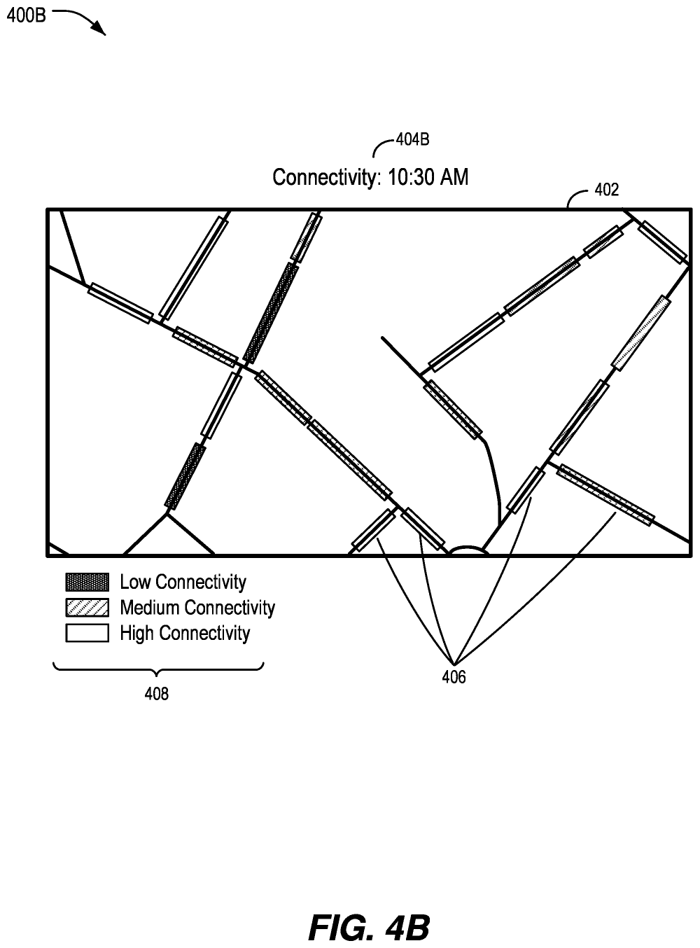

FIG. 4A illustrates an example 400A of a map 404 displaying KPI data 302 for a first time period 402A. The map 404 may be shown on the display screen 216, for example. As shown, the first time period 402A is indicated as being 8:00 AM. The map 404 includes a plurality of road segments 406, such that for road segments 406 where KPI data 302 is available, the map 404 displays the KPI data 302 for the corresponding road segment 406 and the first time period 402A. A segment key 408 may further be provided. The segment key 408 may indicate parameters of the KPI data 302 to the user. For instance, as shown, the segment key 408 divide the KPI data 302 into three categories: low connectivity, medium connectivity, and high connectivity. Each category is represented by a different fill, and those fills are used on the road segments 406 in the map 404 to indicate the level of connectivity. During the first time period 402A, the KPI data 302 indicates relatively poor connectivity.

FIG. 4B illustrates an example 400B of the map 404 displaying KPI data 302 for a second time period 402B. As shown, the second time period 402B is indicated as being 10:30 AM. At this later time, connectivity is shown as being significantly better for many of the road segments 406.

The vehicles 102 may have telematics modems 208 and/or the AV modems 232 with different network capabilities. For instance, these modems may have different capabilities in terms of: mobile network operator (MNO) subscription, supported radio access technology (RAT) (4G/5G, sub-6 GHz, mmWave), supported multiple-input multiple-output (MIMO), etc. Additionally, the telematics controller 202 may maintain information in the storage 206 with respect to the network capabilities of the modems. Accordingly, the vehicle 102 that receives the KPI data 302 to make the map 404, its navigation system uses vehicle modem capabilities to filter the KPI data 302 to include information with respect to connections that are that supported by the telematics modem 208 and/or AV modem 232. Thus, the map 404 may be customized based on the specific capabilities of the modem's capability. Different vehicles may have different KPI data displaying on the map even at the same location, the same time.

In addition, an occupant of the vehicles 102 may add connectivity augmentation as an input of a route to a destination. For instance, the occupant may prefer a high download throughput along the route, at least medium upload throughput along the route, 5G connectivity along the route, low latency along the route, to always remain connected, etc. As one use case, a computer-aided design (CAD) designer may want to work while in an AV ride, and CAD applications may require significant transfer of data. In another example, a day-trader may wish to monitor stock with constant connectivity and/or low latency. For a road segment 406 without connectivity augmentation, the occupant may choose to include or exclude such road segment 406 from the route planning. If the occupant wants to plan a route ahead of time, a fleet operator may suggest to the occupant an appropriate start time to meet the occupant's connectivity needs. It should be noted that the routes from start location to end location may differ for different start times. Thus, the map 404 allows the vehicle 102 to provide better connectivity services to occupants.

The telematics controller 202 may be configured to execute the navigation application 236 to plan a route for the vehicle 102 occupant. For planning the route, the navigation application 236 may combine various factors including: vehicle traffic and filtered KPI data 302. The navigation application 236 may be configured to determine one or more routes from the start location to the end location. For instance, a first route may be determined considering vehicle traffic or travel time without connectivity factors, a second route may be determined preferring 4G connectivity, a third route may be determined preferring 4G/5G connectivity, a fourth route may be determined in view of average downlink and/or uplink speed (e.g., calculated based on travel time of each segment) being at least a threshold amount, and/or a fifth route may be determined in view of an average latency (e.g., calculated based on travel time of each segment) being less than a predefined threshold. One or more such routes may be displayed to the occupant, e.g., via the displays 216, such that the occupant may select from the routes based on his or her preferences.

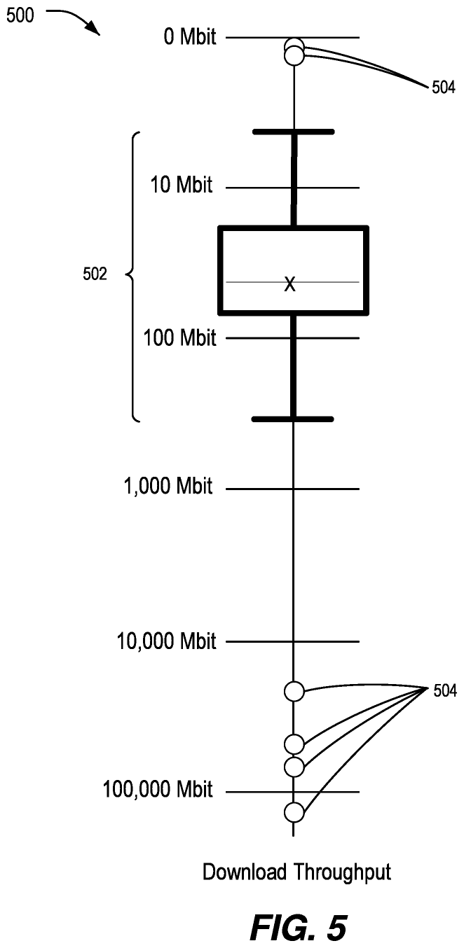

FIG. 5 illustrates an example distribution 500 of KPI data 302 for a road segment 406. In particular, the distribution 500 is for a download throughput parameter. As shown, collected KPI data 302 from vehicles 102 is shown along an axis of throughput in Mbit/sec. This data is illustrated in the distribution 500 as a box and whisker plot 502, with the minimum, first quartile, median, third quartile, and maximum shown. The box of the plot shows the interquartile range (IQR) from the first to third quartile, while the whiskers extend from the first quartile minus 1.5 times the IQR to the third quartile plus 1.5 times the IQR. However, there may also be outlier data elements 504 that are not considered in the distribution 500. In an example, the outlier data elements 504 may be those elements outside the whiskers of the plot. In another example, outlier data elements 504 may be those elements outside the first quartile minus three times the IQR to the third quartile plus three times the IQR. Other outlier criteria may additionally or alternately be used. By eliminating such outliers from the KPI data 302, a better estimate of the KPI data 302 may be performed.

While these outlier data elements 504 may not be relevant to the actual KPI being measured, they may be indicative of equipment or other issues. For instance, very low outlier data elements 504 may be indicative of poorly performing modems, while unrealistically high outlier data elements 504 may be indicative of data reporting issues or other types of communication errors. The AV data server 110 may accordingly store these outliers, along with additional information such as IMSI VIN, location, time, MNO, RAT, other KPI, etc.

In an example, the AV data server 110 may store these outlier data elements 504 including IMSI and may track the connectivity performance in other road areas using the IMSI. If the same modems show abnormal data, it implies those modems may have technical issues. On demand or periodically (for example, weekly), the AV data server 110 may collect the outlier data elements 504 in a report. If outlier data elements 504 appears many times in these weekly reports over a certain time period (e.g. monthly), these outlier modems may have malfunctioned. The AV data server 110 may contact technicians, dealers, or vehicle 102 owners to investigate/troubleshoot the modem (e.g. RF issue, or hardware/software issue, or subscription issue with MNO).

The AV data server 110 may also run other analysis for outliers based on vehicle 102 model/year. If the KPI data 302 have a common model/year, this may indicate those modems have the same technical issues. The AV data server 110 may also compare the KPI data 302 between different vehicle 102 model/year to verify if a new model/year modems have different performance than expected. This comparison may be done using all data including the outlier data elements 504. The AV data server 110 may also contact the MNO to find out if there are any account configuration issues with these modems IMSIs.

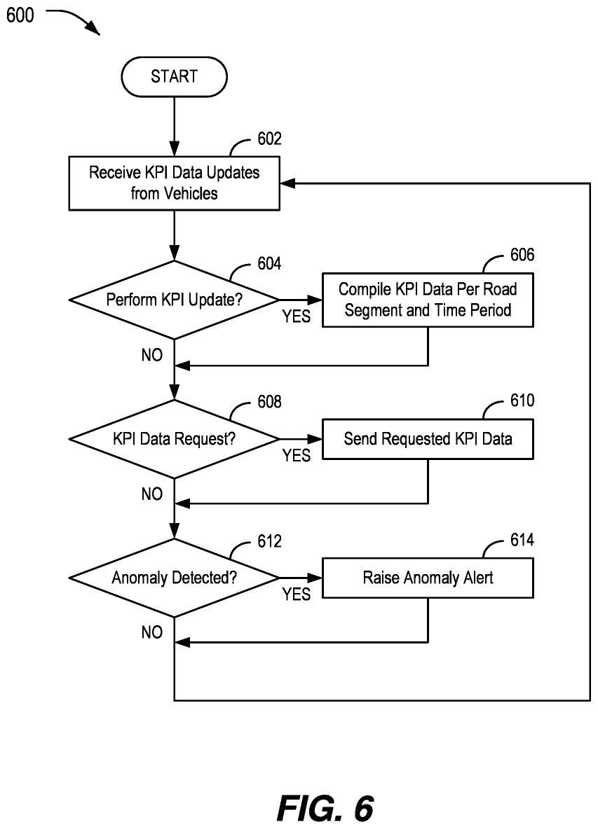

FIG. 6 illustrates an example process 600 for the collection, summarizing, and dissemination of reported KPI data 302. In an example, the process 600 may be performed by the AV data server 110 in the context of the system 100.

At operation 602, the AV data server 110 receives KPI data 302 from vehicles 102. The KPI data 302 may be determined by the vehicles 102 using the telematics modem 208 and/or the AV modem 232 and be sent by the vehicles 102 to the AV data server 110 via the wide-area network 104. The KPI data 302 may further include road segment 406 and timing information for when and where the KPI data 302 was captured. The vehicles 102 may periodically upload KPI data 302 to the AV data server 110. If connectivity is unavailable, the vehicles 102 may store the KPI data 302 and upload at a time where there is connectivity. The vehicles 102 may also piggyback the sensing and upload if a vehicle 102 occupant is using wireless services (e.g., via connection of the telematics controller 202 to a mobile device 210 of the occupant.

At operation 604, the AV data server 110 determines whether to perform a KPI data 302 update. In an example, the AV data server 110 may periodically update the KPI data 302. In another example, the AV data server 110 may update the KPI data 302 responsive to a request, such as from an administrative user of the AV data server 110. In yet another example, the AV data server 110 may update the KPI data 302 responsive to receipt of a predetermined quantity of KPI data 302 from vehicles 102. If KPI data 302 is indicated, control passes to operation 606. If not, control continues to operation 608.

At operation 606, the AV data server 110 compiles the KPI data 302 per road segment 406 and time period 402. In an example, based on the road segment 406 and timing information included in the KPI data 302 received from vehicles at operation 602, the AV data server 110 identifies KPI per road segment 406 and time period 402. To improve the accuracy of the compilation, the AV data server 110 may exclude outlier data elements 504 as discussed above. After operation 606, control continues to operation 608.

At operation 608, the AV data server 110 determines whether a request for KPI data 302 is received. In an example, a vehicle 102 may send a request to the AV data server 110 over the wide-area network 104 for KPI data 302 for an area in which the vehicle 102 is located or intends to travel. This may include, for example, a specification of one or more road segments 406 for which KPI data 302 is desired and/or one or more time periods 402 for which KPI data 302 is desired.

At operation 610, the AV data server 110 sends the KPI data 302 to the vehicle 102 over the wide-area network 104, as compiled at operation 606. After operation 610, control continues to operation 612.

At operation 612, the AV data server 110 determines whether any anomalies are detected with respect to the compiling of KPI data 302 at operation 606. For instance, the AV data server 110 may store outlier data elements 504 identified at operation 606 including IMSI and may track the connectivity performance in other road areas using the IMSI. If the same modems show abnormal data, it implies those modems may have technical issues. On demand or periodically (for example, weekly), the AV data server 110 may collect the outlier data elements 504 in a report. If outlier data elements 504 appears many times in these reports over a certain time period, these outlier modems may have malfunctioned. The AV data server 110 may also run other analysis for outliers based on vehicle 102 model/year. If the KPI data 302 have a common model/year, this may indicate those modems have the same technical issues. The AV data server 110 may also compare the KPI data 302 between different vehicle 102 model/year to verify if a new model/year modems have different performance than expected. This comparison may be done using all data including the outlier data elements 504. The AV data server 110 may also contact the MNO to find out if there are any account configuration issues with these modems IMSIs. If any such anomalies are detected, control passes to operation 614.

At operation 614, the AV data server 110 raises an anomaly alert. In an example, the AV data server 110 may contact technicians, dealers, or vehicle 102 owners to investigate/troubleshoot the modem (e.g. RF issue, or hardware/software issue, or subscription account issue with MNO). After either of operations 612 and 614, control returns to operation 602.

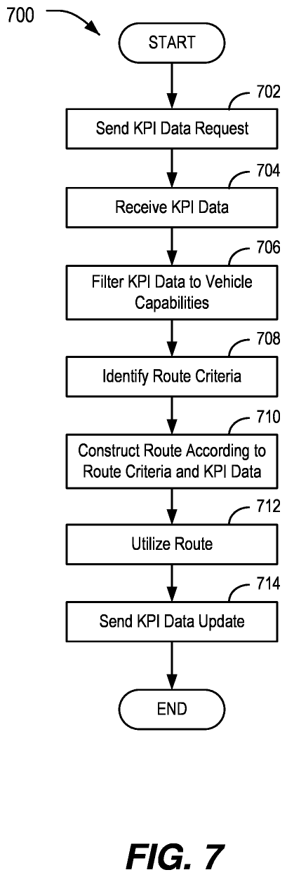

FIG. 7 illustrates an example process 700 for the operation of the vehicles 102 using the KPI data 302 services of the AV data server 110. In an example, the process 600 may be performed by the navigation application 236 as executed by one of the vehicles 102 in the context of the system 100.

At operation 702, and as discussed above at operation 608, the vehicle 102 sends a request to the AV data server 110 for KPI data 302 for routing from a start location to an end location. At operation 704, and as discussed above at operation 610, the vehicle 102 receives the KPI data 302 as requested.

At operation 706, the vehicle 102 filters the KPI data 302 according to capabilities of the vehicle 102. In an example, the vehicle 102 uses vehicle modem capabilities of the telematics modem 208 and/or AV modem 232 to filter the KPI data 302 to include information with respect to connections that are supported by the telematics modem 208 and/or AV modem 232. Thus, the map 404 may be customized based on the specific capabilities of the modem's capability.

At operation 708, the vehicle 102 identifies route criteria. This route criteria may include, for example, bandwidth requirements, requirements to maintain connectivity, requirements to use a certain type of network technology, etc. In some examples, the route criteria may be input by the occupant of the vehicle 102. In other examples, the route criteria may be previously stored to the vehicle 102 for pre-defined type of services. In yet a further example, the vehicle 102 may use different sets of route criteria to generate a set of multiple different routes.

At operation 710, the vehicle 102 constructs the route according to the route criteria and the KPI data 302. The routing may be performed from the start location to the end location using various routing algorithms, such as Dijkstra's shortest path, the Bellman-Ford algorithm, over the graph of road segments 406. Road segments 406 failing to meet the route criteria may be excluded from the determination of the route, or may be weighted less favorably in the determination of the route.

At operation 712, the vehicle 102 utilizes the route. In an example, the vehicle 102 may display the route to the occupant for the occupant or a driver to follow. In another example, the vehicle 102 may utilize the AV controller 222 to autonomously or semi-autonomously navigate the vehicle 102 along the route. The vehicle 102 may also gather KPI data 302 along the route as the vehicle 102 travels.

At operation 714, the vehicle 102 sends the gathered KPI data 302 to the AV data server 110. This allows the AV data server 110 to continue to receive KPI data 302 update to continue the refining of the KPI data 302. After operation 714, the process 700 ends.

Computing devices described herein, such as the autonomous vehicle data server 110, telematics controller 202, mobile device 210, controllers 220, and autonomous vehicle controller 222, generally include computer-executable instructions where the instructions may be executable by one or more computing devices such as those listed above. Computer-executable instructions, such as those of the navigation application 236, may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for using key performance indicator (KPI) data sensed by vehicles, comprising:
a data server programmed to:
receive, over a wide-area network from a plurality of vehicles, connectivity data of modems of the plurality of vehicles to the wide-area network, the connectivity data indicating KPI data, which road segment was being traversed when the KPI data was captured, and a time period during which the KPI data was captured;
identify outlier data elements in the KPI data using outlier detection criteria; and
compile the KPI data per road segment and time period excluding the outlier data elements.

2. The system of claim 1, wherein the outlier detection criteria include a lower boundary of a first quartile of the KPI data minus 1.5 times an interquartile range of the KPI data and an upper boundary of a third quartile of the KPI data plus 1.5 times the interquartile range of the KPI data.

3. The system of claim 1, wherein the outlier detection criteria include a lower boundary of a first quartile of the KPI data minus three times an interquartile range of the KPI data and an upper boundary of a third quartile of the KPI data plus three times the interquartile range of the KPI data.

4. The system of claim 1, wherein the data server is further programmed to:
store outlier data elements for a test modem including an IMSI corresponding to the test modem;
track connectivity performance of the IMSI along other road segments; and
responsive to identifying additional outlier data elements for the IMSI along the other road segments, raise an alert with respect to the test modem.

5. The system of claim 1, wherein the data server is further programmed to responsive to identifying, from the KPI data, a subset of the modems associated with the outlier data elements that have a common vehicle model or vehicle year, raise an alert with respect to the subset of the modems for the common vehicle model or vehicle year.

6. The system of claim 1, wherein the data server is further programmed to:
identify, from the KPI data, a first quantity of outlier data elements for a first subset of the modems that have a common vehicle model or vehicle year;
identify, from the KPI data, a second quantity of outlier data elements for a second subset of the modems that have a second common vehicle model or vehicle year; and
raise an alert with respect to the second subset of the modems due to the second quantity of outlier data elements being higher than the first quantity of outlier data elements.

7. The system of claim 1, wherein the data server is further programmed to responsive to identifying, from the KPI data, a subset of the modems associated with the outlier data elements and a common account configuration, raise an alert with respect to the subset of the modems for the common account configuration.

8. The system of claim 1, wherein the data server is further programmed to:
receive, from one of the plurality of vehicles, a request for the KPI data for a road segment and time period;
send the KPI data, as requested, to the one of the plurality of vehicles;
receive, from the one of the plurality of vehicles, actual KPI data captured by the one of the plurality of vehicles; and
recompile the KPI data per road segment and time period utilizing the actual KPI data.

9. The system of claim 1, wherein the data server is further programmed to:
receive, from the plurality of vehicles, actual KPI data captured by the plurality of vehicles; and
periodically compile the KPI data, including the actual KPI data, per road segment and time period excluding the outlier data elements.

10. A vehicle using KPI data sensed by vehicles, comprising:
one or more modems, each configured to communicate over a wide-area network and to capture KPI data with respect to connection of the one or more modems to the wide-area network; and
a processor, programmed to
send a request to a data server for KPI data for constructing a route from a start location to an end location,
receive the KPI data as requested,
filter the KPI data according to capabilities of the vehicle, the capabilities including one or more of frequencies supported by the one or more modems of the vehicle or network operator or network technologies supported by the one or more modems, and
construct the route according to route criteria and the KPI data.

11. The vehicle of claim 10, wherein the processor is further programmed to:
gather actual KPI data along the route as the vehicle travels; and
send the actual KPI data to the data server for processing.

12. The vehicle of claim 10, wherein the route criteria includes, one or more of bandwidth requirements, requirements to maintain connectivity, or requirements to use a certain type of network technology, or requirement to use a the network operator.

13. The vehicle of claim 10, wherein the route criteria is received from an occupant of the vehicle.

14. The vehicle of claim 10 wherein the processor is further programmed to:
construct a second route according to second route criteria and the KPI data;
display, to a user, a selection between the route using the route criteria and the second route using the second route criteria;
receive a selection of the route or the second route; and
utilize the route or the second route as selected.

15. A method for using KPI data sensed by vehicles, comprising:
receiving, over a wide-area network from a plurality of vehicles, KPI data of modems of the plurality of vehicles to the wide-area network, the KPI data further indicating which road segment was being traversed when the KPI data was captured and a time period during which the KPI data was captured;
identifying outlier data elements in the KPI data using outlier detection criteria;
compiling the KPI data per road segment and time period excluding the outlier data elements;
receiving, from one of the plurality of vehicles, a request for the KPI data for a road segment and time period;
sending the KPI data, as requested, to the one of the plurality of vehicles;
receiving, from the one of the plurality of vehicles, actual KPI data captured by the one of the plurality of vehicles; and
recompiling the KPI data per road segment and time period utilizing the actual KPI data.

16. The method of claim 15, further comprising:
receiving, to the one of the plurality of vehicles, the KPI data as requested;
filtering, by from the one of the plurality of vehicles, the KPI data according to capabilities of the one of the plurality of vehicles, the capabilities including one or more of frequencies supported by one or more modems of the one of the plurality of vehicles or network operator or network technologies supported by the one or more modems, and
construct a route according to route criteria and the KPI data, the route criteria including one or more of bandwidth requirements, requirements to maintain connectivity, or requirements to use the network operator, or requirements to use a certain type of network technology.

17. The method of claim 15, further comprising:
storing outlier data elements for a test modem including an IMSI corresponding to the test modem;
tracking connectivity performance of the IMSI along other road segments; and
responsive to identifying additional outlier data elements for the IMSI along the other road segments, raising an alert with respect to the test modem.

18. The method of claim 15, further comprising responsive to identifying, from the KPI data, a subset of the modems associated with the outlier data elements that have a common vehicle model or vehicle year, raising an alert with respect to the subset of the modems for the common vehicle model or vehicle year.

19. The method of claim 15, further comprising:
identifying, from the KPI data, a first quantity of outlier data elements for a first subset of the modems that have a common vehicle model or vehicle year;
identifying, from the KPI data, a second quantity of outlier data elements for a second subset of the modems that have a second common vehicle model or vehicle year; and
raising an alert with respect to the second subset of the modems due to the second quantity of outlier data elements being higher than the first quantity of outlier data elements.

20. The method of claim 15, further comprising responsive to identifying, from the KPI data, a subset of the modems associated with the outlier data elements and a common account configuration, raising an alert with respect to the subset of the modems for the common account configuration.
